(19) United States
(12) Patent Application Publication
(10) Pub. No.: US 2024/0103937 A1
(43) Pub. Date: Mar. 28, 2024

(54) INFORMATION PROCESSING APPARATUS, NON-TRANSITORY COMPUTER READABLE MEDIUM, AND METHOD

(71) Applicant: FUJIFILM BUSINESS INNOVATION CORP., Tokyo (JP)

(72) Inventor: Junya YAMADA, Kanagawa (JP)

(73) Assignee: FUJIFILM BUSINESS INNOVATION CORP., Tokyo (JP)

(21) Appl. No.: 18/182,469

(22) Filed: Mar. 13, 2023

(30) Foreign Application Priority Data
Sep. 27, 2022 (JP) 2022-153356

(51) Int. Cl. G06F 9/54

(52) U.S. Cl. CPC G06F 9/54

(57) ABSTRACT

An information processing apparatus includes a processor. For each of applications, a device necessary to display a screen for the application and a device necessary to execute the application are defined. The processor is configured to activate an application if a device necessary to display a screen for the application has been restored in a case where an instruction to activate the application is given after an operation for turning on the information processing apparatus is performed.

### CROSS-REFERENCE TO RELATED APPLICATIONS

This application is based on and claims priority under 35 USC 119 from Japanese Patent Application No. 2022-153356 filed Sep. 27, 2022.

### BACKGROUND

### (i) Technical Field

The present disclosure relates to an information processing apparatus, a non-transitory computer readable medium, and a method.

### (ii) Related Art

In Japanese Patent No. 5561393, an apparatus that determines, on the basis of whether a user can use software resources or hardware resources employed by an application, whether the user can use the application.

### SUMMARY

Time taken to display a screen (e.g., a setting screen) for an application after an operation for turning on an apparatus is performed is sometimes shorter than time taken to restore a device necessary to execute the application after the operation for turning on the apparatus is performed. If the screen for the application is not displayed until a device necessary to execute the application is restored in this case, it is difficult to perform an operation on the screen for the application until the device necessary to execute the application is restored.

Aspects of non-limiting embodiments of the present disclosure relate to making it possible to perform an operation on a screen for an application even when a device necessary to execute the application has not been restored after an operation for turning on an apparatus was performed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor, wherein, for each of applications, a device necessary to display a screen for the application and a device necessary to execute the application are defined, wherein the processor is configured to activate an application if a device necessary to display a screen for the application has been restored in a case where an instruction to activate the application is given after an operation for turning on the information processing apparatus is performed.

### BRIEF DESCRIPTION OF THE DRAWINGS

An exemplary embodiment of the present disclosure will be described in detail based on the following figures, wherein:

FIG. 1 is a block diagram illustrating the hardware configuration of an image forming apparatus according to an exemplary embodiment;

FIG. 2 is a block diagram illustrating functions of the image forming apparatus according to the exemplary embodiment;

FIG. 3 is a diagram illustrating an example of a management table for devices;

FIG. 4 is a flowchart illustrating a process relating to activation of an application;

FIG. 5 is a diagram illustrating an example of a menu screen;

FIG. 6 is a diagram illustrating another example of the menu screen;

FIG. 7 is a diagram illustrating an example of a screen for an application;

FIG. 8 is a flowchart illustrating a process relating to execution of an application;

FIG. 9 is a diagram illustrating another example of the screen for an application;

FIG. 10 is a flowchart illustrating a process relating to activation and execution of an unregistered application;

FIG. 11 is a diagram illustrating another example of the management table for devices; and

FIG. 12 is a diagram illustrating another example of the management table for devices.

### DETAILED DESCRIPTION

An information processing apparatus according to an exemplary embodiment will be described hereinafter. The information processing apparatus according to the exemplary embodiment has a function of controlling supply of power thereto, and may be any apparatus having the function.

The information processing apparatus includes one or plural devices (i.e., hardware). In the information processing apparatus, one or plural applications are executed. When an application is executed, a certain process or operation is achieved. In order to execute an application, a program (i.e., software) and a device are used. A device necessary to display screens for an application and a device necessary to execute an application are defined for each application.

Screens for an application include, for example, a screen for making settings necessary to execute the application (e.g., a setting screen) and a screen for checking execution of the application (e.g., a check screen).

A device necessary to execute an application is a device used to perform a process or an operation achieved through the execution of the application.

A device necessary to display screens for applications will be referred to as a “display device” hereinafter, and a device necessary to execute an application will be referred to as an “execution device” hereinafter.

When an instruction to activate an application is given after an operation for turning on the information processing apparatus is performed, the application is activated if a display device for the application has been restored. A state where a device has been restored refers to a state where power is supplied to the device and the device can be used.

States of a power supply of the information processing apparatus (i.e., power supply states) will be described. The states of the power supply of the information processing apparatus include, for example, a power-on state, a power-off state, a sub-power-off state, and a suspended state. These states of the power supply are examples, and other states of the power supply may be used, instead.

The power-on state is a state where power is supplied to the devices included in the information processing apparatus and the information processing apparatus has been activated and a state where the information processing apparatus can perform processes and operations.

The power-off state is a state where power is not supplied to the devices included in the information processing apparatus at all and the devices are not energized at all. A state where the power supply of the information processing apparatus is unplugged, for example, corresponds to the power-off state.

The sub-power-off state is a state where the power supply of the information processing apparatus is plugged and a state where the information processing apparatus can be activated by performing an operation for turning on the information processing apparatus (e.g., pressing a power button). A state where power is supplied to only some of the devices included in the information processing apparatus (e.g., a memory and a device for detecting pressing of the power button) and only these devices are energized, for example, corresponds to the sub-power-off state. In the sub-power-off state, the devices (i.e., hardware) are reset and programs (i.e., software) are restarted. When a user performs an operation for turning off the information processing apparatus (e.g., presses the power button) and the power supply enters the sub-power-off state from the power-on state, for example, the devices are reset and the programs are restarted. The devices may be reset and the programs may be restarted when the user performs an operation for turning on the information processing apparatus (e.g., presses the power button) with the power supply in the sub-power-off state to change the state of the power supply from the sub-power-off state to the power-on state, instead. When the user turns on the information processing apparatus (e.g., presses the power button) with the power supply in the sub-power-off state, the power supply is restored to the power-on state from the sub-power-off state, and the information processing apparatus is activated.

The suspended state is a state of the power supply achieved by executing a suspension function of the information processing apparatus. The suspended state is a state where the power supply of the information processing apparatus is plugged and a state where the information processing apparatus can be activated by performing an operation for turning on the information processing apparatus (e.g., pressing the power button). A state where power is supplied to only some of the devices included in the information processing apparatus (e.g., the memory and the device for detecting pressing of the power button) and only these devices are energized, for example, corresponds to the suspended state. Power necessary to hold data is supplied to the memory. In the suspended state, unlike in the sub-power-off state, the devices are not reset and the programs are not restarted. When an operation for turning off the information processing apparatus is performed (e.g., the power button is pressed) to change the state of the power supply from the power-on state to the suspended state, information indicating states of programs executed before the power supply enters the suspended state (i.e., states of programs executed before the operation for turning off the information processing apparatus is performed) is stored in the memory (e.g., a random-access memory (RAM)). When an operation for turning on the information processing apparatus is performed (e.g., the power button is pressed) with the power supply in the suspended state, the power supply is restored to the power-on state from the suspended state, and the information processing apparatus is activated. At this time, the programs are not restarted and are restored to the states stored in the memory. As a result, time taken to restore the power supply becomes shorter than when the power supply is restored from the sub-power-off state to the power-on state. In this sense, the suspension function can be regarded as a fast activation function (i.e., a function of activating the information processing apparatus fast) or a fast restoration function.

An exemplary embodiment will be described hereinafter while taking an image forming apparatus as an example of the information processing apparatus, but an apparatus according to the exemplary embodiment is not limited to the image forming apparatus. The present exemplary embodiment may be applied to an apparatus other than the image forming apparatus, instead.

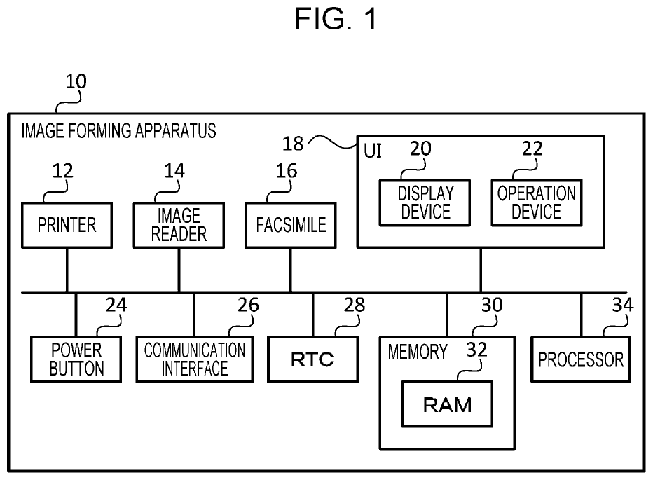

FIG. 1 illustrates the hardware configuration of an image forming apparatus 10, which is an example of the information processing apparatus. The image forming apparatus 10 includes, for example, a printer 12, an image reader 14, a facsimile 16, a user interface (UI) 18, a power button 24, a communication interface 26, a real-time clock (RTC) 28, a memory 30, and a processor 34.

The printer 12 prints images on a recording medium such as sheets of paper. A printing method is not particularly limited, and may be electrophotography, an inkjet method, or the like. The image reader 14 is a scanner, for example, and reads images from sheets of paper or the like. The printer 12 and the image reader 14 together achieve a copying function. The facsimile 16 transmits and receives information using a facsimile function. Although the image forming apparatus 10 includes the printer 12, the image reader 14, and the facsimile 16 in the example illustrated in FIG. 1, the image forming apparatus 10 may include at least the printer 12, the image reader 14, or the facsimile 16, instead. The image forming apparatus 10 may be a multifunction device including some of the printer 12, the image reader 14, and the facsimile 16, instead.

The UI 18 includes, for example, a display device 20 and an operation device 22. The display device 20 is a liquid crystal display, an electroluminescent (EL) display, or the like. The operation device 22 is a keyboard, a mouse, an input key, an operation panel, or the like. The UI 18 may be a touch panel, instead.

The power button 24 is a button for turning on and off the image forming apparatus 10.

If the power button 24 is pressed with the power supply of the image forming apparatus 10 in the power-on state, the power supply of the image forming apparatus 10 enters the sub-power-off state or the suspended state from the power-on state. It is determined in advance, for example, that when the hardware need not be reset and the programs need not be restarted, the power supply enters the suspended state, and if the hardware needs to be reset and the programs need to be restarted, the power supply enters the sub-power-off state. A case where an abnormality that can be eliminated by resetting the hardware or restarting the programs has occurred in the image forming apparatus 10, for example, is an example of a case where the hardware needs to be reset and the programs need to be restarted. If the power button 24 is pressed in this case, the power supply enters the sub-power-off state. If the power button 24 is pressed without such an abnormality having been occurred in the image forming apparatus 10, the power supply enters the suspended state. It is needless to say that the power supply may enter the sub-power-off state or the suspended state in accordance with a condition other than that described above, instead. The user may set the condition.

If the power button 24 is pressed with the power supply of the image forming apparatus 10 in the sub-power-off state or the suspended state, the power supply of the image forming apparatus 10 enters the power-on state from the sub-power-off state or the suspended state. More specifically, a process for restoring the devices and a process for restoring the programs are performed. In the process for restoring the devices, power is supplied to the devices. When the devices have been restored by supplying power to the devices, the devices can be used. In the process for restoring the programs, the programs are activated. When the programs have been activated, the programs can be used. In the suspended state, the programs are restored to the states stored in a RAM 32.

The communication interface 26 includes a communication chip and a communication circuit and has a function of transmitting information to other apparatuses and a function of receiving information from other apparatuses. The communication interface 26 may have a wireless communication function such as near-field communication or Wi-Fi (registered trademark) or a wireless communication function.

The RTC 28 generates information such as time, date, month, and year from a clock source and outputs the information.

The memory 30 is a device that serves as one or plural storage areas storing data. The memory 30 includes the RAM 32. The memory 30 may also include a hard disk drive (HDD), a solid-state drive (SSD), one of various memories other than the RAM 32 (e.g., a nonvolatile memory or a volatile memory), another storage device (e.g., an optical disc), or the like. For example, the memory 30 includes a boot read-only memory (ROM) storing a program for activating the image forming apparatus 10.

For example, the memory 30 stores device management information for managing the devices (i.e., hardware) included in the image forming apparatus 10. The device management information is information indicating the applications installed on the image forming apparatus 10 and devices used for the applications. More specifically, the device management information indicates, for each application, an association between the application, a display device for the application, and an execution device for the application.

The processor 34 controls the operation of the other components of the image forming apparatus 10. For example, the processor 34 controls printing performed by the printer 12, reading of images performed by the image reader 14, transmission and reception of information performed by the facsimile 16, and communication performed by the communication interface 26.

When an instruction to activate an application is given after an operation for turning on the image forming apparatus 10 is performed (i.e., after the power button 24 is pressed), the processor 34 activates the application if a display device for the application has been restored (i.e., if the display device can be used). When software is used to execute the application, the processor 34 activates the software.

If the display device for the application has not been restored (i.e., if the display device is not available), the processor 34 does not activate the application.

If an execution device for the application has not been restored (i.e., if the execution device is not available) after the application was activated, the processor 34 does not execute the application even when an instruction to execute the application is given. If an instruction to execute the application is given after the execution device has been restored, the processor 34 executes the application.

If the execution device for an application has not been restored after the application was activated, the processor 34 need not receive an instruction to execute the application. If the execution device has been restored, the processor 34 may receive an instruction to execute the application.

Each of the printer 12, the image reader 14, the facsimile 16, the UI 18, the power button 24, the communication interface 26, the RTC 28, the memory 30, and the processor 34 corresponds to an example of a device included in the image forming apparatus 10.

As the states of the power supply of the image forming apparatus 10, for example, the power-on state, the power-off state, the sub-power-off state, and the suspended state are defined.

In the suspended state, power is supplied to only the device for detecting pressing of the power button 24 and the RAM 32. The RAM 32 supplies power necessary to hold data. When the power supply enters the suspended state from the power-on state, information indicating states of programs executed before the power supply enters the suspended state (i.e., states of programs before the power button 24 is pressed) is stored in the RAM 32. When the power button 24 is pressed and the pressing is detected with the power supply in the suspended state, the power supply is restored to the power-on state from the suspended state, and the image forming apparatus 10 is activated. At this time, the programs are not restarted, and are restored to the states stored in the RAM 32.

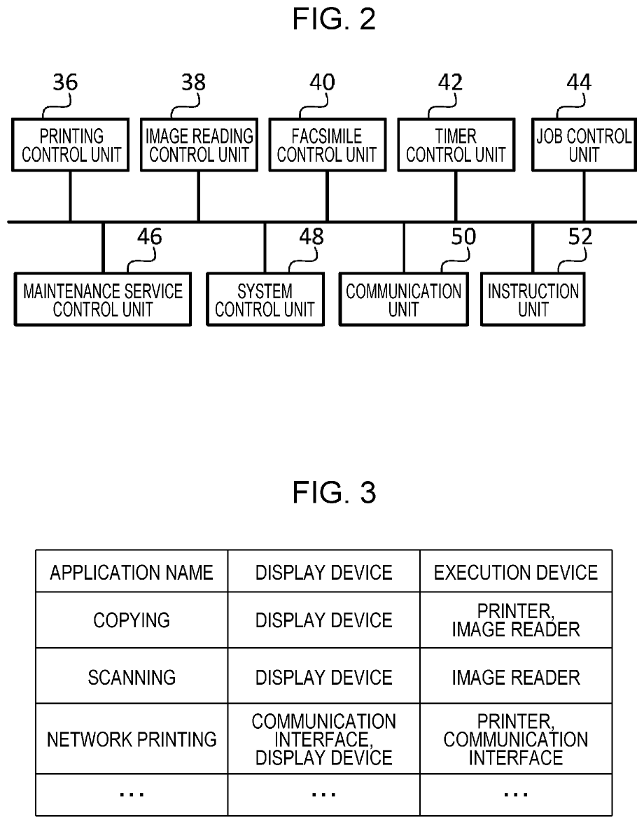

FIG. 2 illustrates an example of functions of the image forming apparatus 10.

A printing control unit 36 controls printing performed by the printer 12. An image reading control unit 38 controls reading of images performed by the image reader 14. A facsimile control unit 40 controls transmission and reception of information performed by the facsimile 16. A timer control unit 42 manages time on the basis of outputs of the RTC 28. A job control unit 44 controls execution of jobs (e.g., print jobs) executed by the image forming apparatus 10. A maintenance service control unit 46 controls execution of a maintenance service for the image forming apparatus 10 and the like. A system control unit 48 controls a whole system of the image forming apparatus 10. A communication unit 50 performs communication using the communication interface 26. An instruction unit 52 receives various instructions and outputs the instructions to relevant components.

FIG. 3 illustrates an example of a management table for devices. The management table is an example of the above-described device management information and stored in the memory 30.

The applications installed on the image forming apparatus 10 and the devices used for the applications are registered in the management table. More specifically, for each application, information indicating a name of the application, information indicating a display device for the application, and information indicating an execution device for the application are associated on the management table with one another. Here, copying, scanning, and network printing are shown as an example of the applications.

The copying is an application achieved by the printer 12 and the image reader 14. The printer 12 and the image reader 14, therefore, are associated with the application “copying” as execution devices. Because the display device 20 is used to display a setting screen for copying, the display device 20 is associated with the application “copying” as a display device.

The scanning is an application achieved by the image reader 14. The image reader 14, therefore, is associated with the application “scanning” as an execution device. Because the display device 20 is used to display a setting screen for scanning, the display device 20 is associated with the application “scanning” as a display device.

The network printing is an application for obtaining image data stored in external apparatuses (e.g., cloud servers, image servers, personal computers, and smartphones) and printing the image data.

When the application “network printing” is activated, the image forming apparatus 10 accesses an external apparatus using the communication interface 26. As a result, image data stored in the external apparatus is displayed on the display device 20 as candidates for printing. The communication interface 26 and the display device 20 are used to display image data, which is candidates for printing, on the image forming apparatus 10. The communication interface 26 and the display device 20, therefore, are associated with the application “network printing” as display devices.

When the user selects, among candidates for printing, a piece of image data to be printed and gives an instruction to print the piece of image data, the image forming apparatus 10 obtains (e.g., downloads) the piece of image data to be printed from an external apparatus using the communication interface 26 and prints the piece of image data using the printer 12. The printer 12 and the communication interface 26 are thus used to print image data. The printer 12 and the communication interface 26, therefore, are associated with the application “network printing” as execution devices.

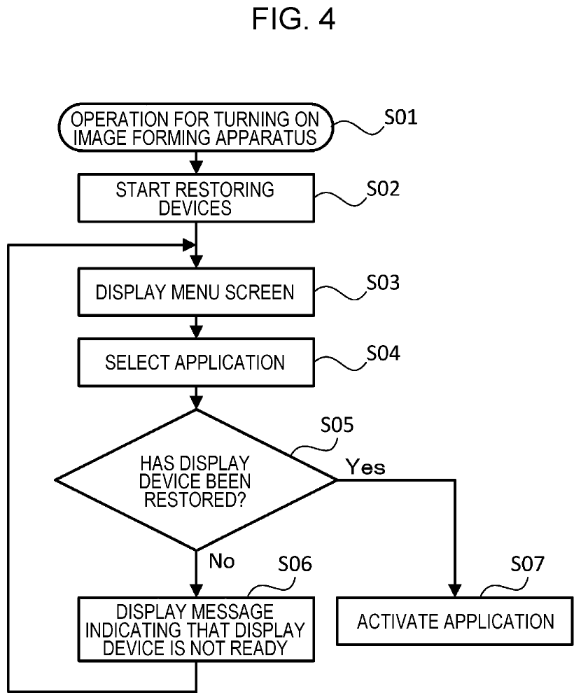

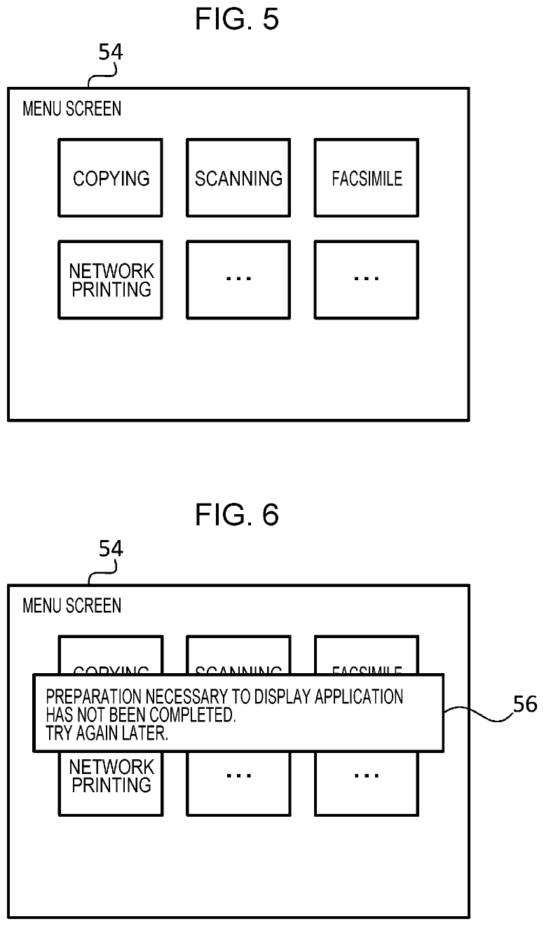

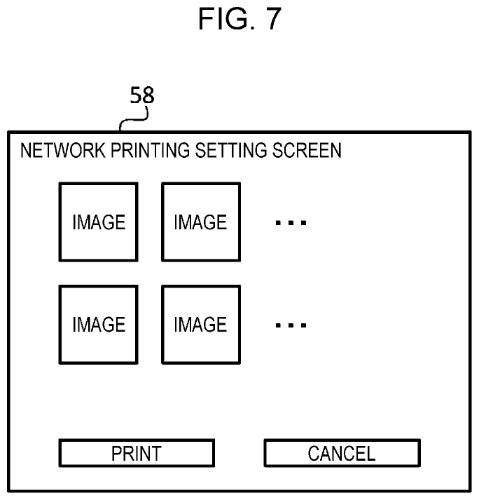

An operation performed by the image forming apparatus 10 will be described hereinafter with reference to FIGS. 4 to 7. Here, a process relating to activation of an application will be described. FIG. 4 is a flowchart illustrating the process relating to the activation of an application. FIGS. 5 and 6 illustrate examples of a menu screen. FIG. 7 illustrates an example of a screen for an application.

It is assumed that the power supply of the image forming apparatus 10 is in the sub-power-off state or the suspended state.

First, the user performs an operation for turning on the image forming apparatus 10 (S01). More specifically, the user presses the power button 24.

When the pressing of the power button 24 is detected, restoration of the devices included in the image forming apparatus 10 starts (S02). More specifically, power is supplied to the devices, and the process for restoring the devices and the process for restoring the programs are performed.

When the display device 20 and the processor 34 have been activated by supplying power to the display device 20 and the processor 34 and the programs have been restored and become executable, the processor 34 displays the menu screen on the display device 20 (S03).

FIG. 5 illustrates an example of the menu screen. The processor 34 displays a menu screen 54 on the display device 20. The menu screen 54 shows a list of applications (e.g., a list of images, such as icons, indicating the applications). Here, icons indicating copying, scanning, facsimile, and network printing are displayed in the menu screen 54 as an example.

Next, the user selects a target application and gives an instruction to activate the application (S04). More specifically, when one of the icons displayed in the menu screen 54 is pressed, an instruction to activate an application corresponding to the pressed icon is given to the image forming apparatus 10. If the user presses an icon indicating the network printing, for example, an instruction to activate the application “network printing” is given to the image forming apparatus 10.

Upon receiving the instruction to activate an application, the processor 34 determines whether a display device for the application has been restored (S05). That is, the processor 34 determines whether power is supplied to the display device for the application and the display device can be used. More specifically, the processor 34 refers to the management table illustrated in FIG. 3, identifies the display device associated with the application, and determines whether the identified display device has been restored.

If the display device for the application has not been restored (No in S05), the processor 34 does not activate the application and displays, on the display device 20, a message indicating that the display device is not ready (S06). The process proceeds to step S03.

If the display device for the application has been restored (Yes in S05), the processor 34 activates the application (S07). If software is used for the application, the processor 34 activates the software.

When the user selects the application “network printing” and gives an instruction to activate the application “network printing”, for example, the processor 34 determines whether the communication interface 26 and the display device 20 have been restored.

If the communication interface 26 has not been restored (No in S05), the processor 34 does not activate the application “network printing” and displays, on the display device 20, a message indicating that the display device for the application “network printing” is not ready (S06).

FIG. 6 illustrates an example of the displayed message. For example, the processor 34 superimposes a message 56 upon the menu screen 54. The message 56, “Preparation necessary to display application has not been completed. Try again later”, for example, is displayed. The message 56 is displayed, for example, when initialization of the communication interface 26, obtaining of an Internet protocol (IP) address, or the like has not been completed and a network is not accessible.

If the communication interface 26 has been restored (Yes in S05), the processor 34 activates the application “network printing” (S07). For example, the processor 34 displays a setting screen for the network printing on the display device 20.

FIG. 7 illustrates an example of the displayed setting screen. A network printing setting screen 58 is a screen for the application “network printing” and a setting screen for performing the network printing. A list of image data stored in an external apparatus is displayed in the network printing setting screen 58. The user selects, from the list, a piece of image data to be printed. In this sense, the network printing setting screen 58 can also be regarded as an image data selection screen. When the communication interface 26 has been restored, the network printing setting screen 58 is displayed on the display device 20 even if the printer 12, which is an execution device, has not been restored.

As described later, when the printer 12, which is an execution device, has been restored and the user selects, from the list, a piece of image data to be printed and gives an instruction to print the piece of image data (e.g., presses a print button), the image forming apparatus 10 obtains the selected piece of image data from the external apparatus and prints the piece of image data. The job of the network printing is thus performed.

In another example, if the display device 20 has been restored when the user selects the application “copying” on the menu screen 54, the setting screen for the copying is displayed. Even if the restoration of the printer 12, which is an execution device, has not been restored, the setting screen for the copying is displayed. Conditions of sheets of paper and toner, for example, may also be displayed on the setting screen for the copying.

The processor 34 may display, on the display device 20, applications for which a display device has been restored and applications for which a display device has not been restored while distinguishing these applications from each other.

For example, the processor 34 displays images (i.e., icons) indicating the applications for which a display device has been restored and images (i.e., icons) indicating the application for which a display device has not been restored differently on the display device 20.

More specifically, the processor 34 displays the images indicating the applications for which a display device has not been restored on the menu screen 54 in a grayed-out format and the images indicating the applications for which a display device has been restored on the menu screen 54 in a highlighted manner.

The processor 34 may accept an instruction to activate an application for which a display device has been restored and need not accept an instruction to activate an application for which a display device has not been restored.

The processor 34 may accept an instruction to activate an application for which a display device has not been restored, instead. In this case, when the display device for the application has been restored after the processor 34 accepted the instruction to activate the application, the processor 34 may display a screen (e.g., a setting screen) for the application on the display device 20. That is, the processor 34 may accept the instruction to activate the application and wait for completion of the restoration of the display device and, when the display device has been restored, may display the screen for the application on the display device 20. While waiting, the processor 34 may display, on the display device 20, a message indicating that the display device is not ready.

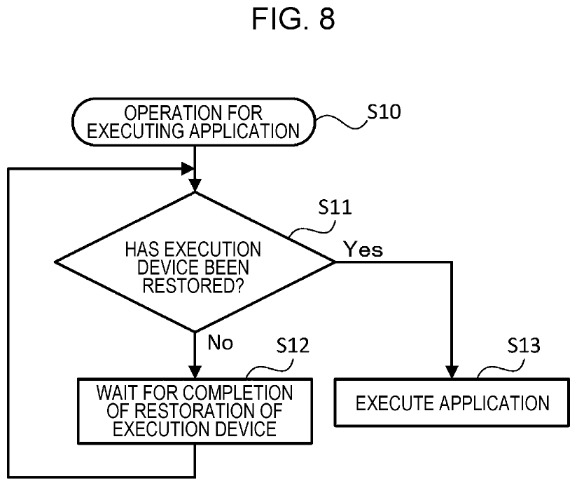

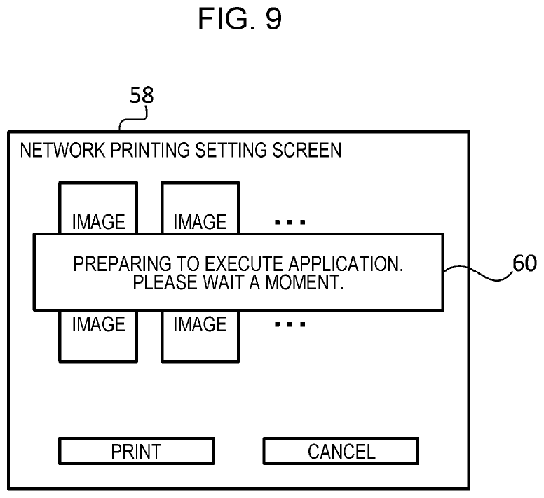

A process relating to execution of an application will be described hereinafter with reference to FIGS. 8 and 9. FIG. 8 is a flowchart illustrating the process relating to the execution of an application. FIG. 9 illustrates an example of a screen for the application.

First, after the application is activated (i.e., after step S07), the user performs an operation for executing the application (S10). For example, the user gives an instruction to execute the application.

It is assumed, for example, that the application “network printing” has been activated and an instruction to execute the application “network printing” has been given in step S07. For example, the user selects, on the network printing setting screen 58, a piece of image data to be printed and gives an instruction to print the piece of image data. The instruction is given, for example, by pressing the print button (e.g., an image such as an icon) displayed in the network printing setting screen 58.

The processor 34 determines whether an execution device for the application has been restored (S11). That is, the processor 34 determines whether power is supplied to the execution device for the application and the execution device can be used. More specifically, the processor 34 refers to the management table illustrated in FIG. 3, identifies the execution device associated with the application, and determines whether the identified execution device has been restored.

When an instruction to execute the application “network printing” is given, the processor 34 determines whether the printer 12 has been restored.

If the execution device for the application has not been restored (No in S11), the processor 34 waits for completion of the restoration of the execution device without executing the application (S12). In this case, the process proceeds to step S11. The processor 34 may display, on the display device 20, a message indicating that the execution device is not ready for the execution.

FIG. 9 illustrates an example of the displayed message. If the printer 12 has not been restored when the instruction to execute the application “network printing” is given (No in S11), the processor 34 superimposes a message 60 upon the network printing setting screen 58. The message 60, “Preparing to execute application. Please wait a moment”, for example, is displayed.

If the execution device is not ready, the processor 34 may display, on the display device 20, information indicating that the execution device is not ready, and cancel the execution of the application. In this case, the process ends without returning to step S11. When the user again gives an instruction to execute the application (S10), step S11 and later steps are performed.

If the execution device for the application has been restored (Yes in S11), the processor 34 executes the application using the execution device (S13).

If the printer 12 has been restored when the instruction to execute the application “network printing” is given (Yes in S11), the processor 34 obtains a piece of image data to be printed (e.g., a piece of image data selected by the user) from an external apparatus using the communication interface 26 and causes the printer 12 to print the piece of image data. As a result, the execution of network printing is completed.

The processor 34 may display, on the display device 20, applications for which an execution device has been restored and applications for which an execution device has not been restored while distinguishing these applications from each other.

For example, the processor 34 displays images (i.e., icons) indicating the applications for which an execution device has been restored and images (i.e., icons) indicating the applications for which an execution device has not been restored differently on the display device 20.

More specifically, the processor 34 displays the images indicating the applications for which an execution device has not been restored on the menu screen 54 in a grayed-out format and the images indicating the applications for which an execution device has been restored on the menu screen 54 in a highlighted manner.

The processor 34 may accept an instruction to activate an application for which an execution device has been restored and need not accept an instruction to execute an application for which an execution device has not been restored.

The processor 34 may accept an instruction to execute an application for which an execution device has not been restored, instead. In this case, when the execution device for the application has been restored after the processor 34 accepted the instruction to execute the application, the processor 34 may execute the application. That is, the processor 34 may accept the instruction to execute the application and wait for completion of the restoration of the execution device and, when the execution device has been restored, may execute the application. While waiting, the processor 34 may display, on the execution device 20, a message indicating that the execution device is not ready.

Applications for which Necessary Devices are not Registered in Image Forming Apparatus 10

Applications for which a display device and an execution device are not registered in the image forming apparatus 10 might be installed on the image forming apparatus 10. When an application is added to the image forming apparatus 10, for example, a display device and an execution device for the application might not be registered in the image forming apparatus 10. More specifically, the display device and the execution device for the application might not be registered in the management table illustrated in FIG. 3. When an application developed by a third-party vendor or the like is installed on the image forming apparatus 10, for example, a display device and an execution device for the application might not be registered in the management table for devices. An application for which a display device and an execution device are not registered in the image forming apparatus 10 can be regarded as an application for which a display device and an execution device are unknown to the image forming apparatus 10.

In the following description, applications for which a display device and an execution device are not registered in the image forming apparatus 10 will be referred to as “unregistered applications”. Unregistered applications are applications for which a display device and an execution device are unknown to the image forming apparatus 10.

A display device and an execution device are set in advance for an unregistered application. When an unregistered application is activated, the unregistered application accesses a display device set therefor. As a result, the display device is used to display a screen for the unregistered application. When an instruction to execute the unregistered application is given, the unregistered application accesses an execution device set therefor. As a result, the execution device is used to execute the unregistered application. That is, the unregistered application achieve processes and operations. A display device and an execution device for an unregistered application are thus set for the unregistered application but not registered in the image forming apparatus 10. In this sense, an unregistered application is an application for which a display device and an execution device are unknown to the image forming apparatus 10.

When an instruction to activate an unregistered application is given, the processor 34 registers, as a device necessary to display a screen for the unregistered application (i.e., a display device), a device accessed before the unregistered application is activated and the screen is displayed after all devices were restored. For example, the processor 34 registers the display device to the management table for devices.

The processor 34 also registers, as a device necessary to execute the unregistered application (i.e., an execution device), a device accessed while the unregistered application is being executed. For example, the processor 34 registers the execution device to the management table for devices.

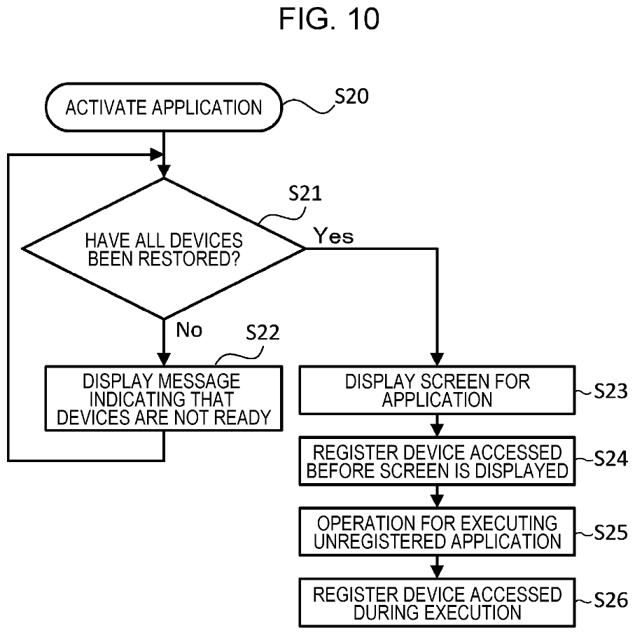

A process performed when an instruction to activate an unregistered application will be described hereinafter with reference to FIG. 10. FIG. 10 is a flowchart illustrating a process relating to activation and execution of an unregistered application.

First, when the user gives an instruction to activate an unregistered application, the processor 34 activates the unregistered application (S20). For example, an image (e.g., an icon) indicating the unregistered application is displayed in the menu screen 54, and the user gives an instruction to activate the unregistered application by pressing the image. Upon receiving the instruction, the processor 34 activates the unregistered application.

Here, an instruction to activate an unregistered application, for which a display device and an execution device are not registered in the management table for devices, is given. When an instruction to activate an application for which a display device and an execution device are registered in the management table for devices is given, a process is performed in accordance with the flowchart of FIG. 4. Upon receiving an instruction to activate an application, for example, the processor 34 determines whether a display device and an execution device for the application are registered in the management table for devices. If a display device and an execution device for the application are registered in the management table for devices, the processor 34 performs a process in accordance with the flowchart of FIG. 4. The processor 34 then performs a process in accordance with the flowchart of FIG. 8. If a display device and an execution device for the application are not registered in the management table for devices, the processor 34 determines that the application is an unregistered application, and performs a process in accordance with the flowchart of FIG. 10.

The processor 34 waits for completion of restoration of all the devices included in the image forming apparatus 10.

If not all the devices have been restored (No in S21), the processor 34 displays, on the display device 20, a message or the like indicating that the devices are not ready (S22). The process proceeds to step S21.

If all the devices have been restored (Yes in S21), the processor 34 displays a screen (e.g., a setting screen) for the unregistered application on the display device 20 (S23). A screen for an unregistered application is set in advance for the unregistered application and displayed on the display device 20 when the unregistered application is activated.

The processor 34 registers, to the management table for devices as the display device for the unregistered application, a device accessed by the activated unregistered application before the screen is displayed (S24). A display device and an execution device are set in advance for an unregistered application. When an unregistered application accesses a display device set therefor, the display device is used to display a screen for the unregistered application on the display device 20. The processor 34 registers the accessed device to the management table for devise as the display device for the unregistered application.

When the user performs an operation for executing the unregistered application (e.g., gives an instruction to execute the unregistered application) after the unregistered application is activated (S25), the processor 34 executes the unregistered application. When the unregistered application accesses the execution device set therefor, the execution device is used to execute the unregistered application. That is, the unregistered application achieve processes and operations.

The processor 34 registers, to the management table for devices as the execution device for the unregistered application, a device accessed by the unregistered application while the unregistered application is being executed (S26).

A display device and an execution device for an unregistered application are thus registered to the management table for devices. In this sense, the unregistered application is no longer an application for which a display device and an execution device are unknown to the image forming apparatus 10. Once a display device and an execution device are registered to the management table, the processor 34 refers to the management table and performs the process relating to the activation of an application (refer to FIG. 4) and the execution of the application (refer to FIG. 8) in later processing.

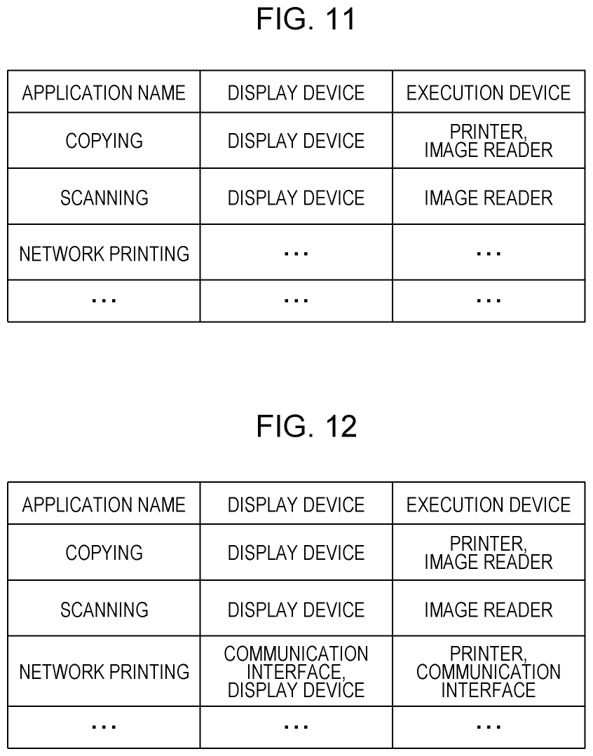

A specific example of an unregistered application will be described hereinafter with reference to FIGS. 11 and 12. FIGS. 11 and 12 illustrate the management table for devices.

It is assumed here, for example, that the application “network printing” is added to the image forming apparatus 10 and activated for a first time.

FIG. 11 illustrates the management table before the application “network printing” is activated. Since the application “network printing” is additionally installed on the image forming apparatus 10, a name of the application “network printing” is registered in the management table. A display device and an execution device for the application “network printing”, on the other hand, are not registered in the management table for devices. The application “network printing”, therefore, is an unregistered application, that is, an application for which a display device and an execution device are unknown to the image forming apparatus 10.

When the user gives an instruction to activate the application “network printing” (S20), steps S21 to S24 are performed. As a result, a device accessed by the activated application “network printing” before the screen is displayed is registered to the management table for devices as the display device for the application “network printing”.

When the user gives an instruction to execute the application “network printing” (S25), step S26 is performed. As a result, a device accessed by the application “network printing” while the application “network printing” is being executed is registered to the management table for devices as the execution device for the application “network printing”.

FIG. 12 illustrates the management table after the application “network printing” is activated and executed.

The activated application “network printing” accesses the communication interface 26 and the display device 20 before the screen is displayed. The communication interface 26 and the display device 20, therefore, are registered to the management table as display devices.

While the application “network printing” is being executed, the application “network printing” accesses the printer 12 and the communication interface 26. The printer 12 and the communication interface 26, therefore, are registered to the management table as execution devices.

Once the display devices and the execution devices are registered to the management table, the processor 34 refers to the management table and performs the process relating to the activation or the execution of the application “network printing” when an instruction to activate or execute the application “network printing” are given.

Example where Screen for Predetermined Application is Displayed

After an operation for turning on the image forming apparatus 10 is performed, a screen for a predetermined application might be to be displayed. The predetermined application will be referred to as a “default application” hereinafter, and the screen for the predetermined application will be referred to as a “default screen”. The default screen is, for example, a setting screen for the default application.

Information indicating the default application and information indicating the default screen are stored in the memory 30. When the user selects the default application using the UI 18, for example, information indicating the selected application is stored in the memory 30 as information indicating the default application. Information indicating a screen for the selected application is also stored in the memory 30 as information indicating the default screen.

When a screen for application “network printing” is defined as the default screen, the processor 34 displays, after the image forming apparatus 10 is activated, the screen for the application “network printing” (e.g., the network printing setting screen 58) on the display device 20. In another example, when a screen for the application “copying” is defined as the default screen, the processor 34 displays, after the image forming apparatus 10 is activated, the screen for the application “copying” (e.g., the setting screen for the copying) on the display device 20.

That is, although the menu screen 54 is first displayed on the display device 20 after the image forming apparatus 10 is activated in the example illustrated in FIG. 4 (S03), the default screen is displayed on the display device 20 here instead of the menu screen 54.

When the default screen is set and a device necessary to display the default screen (a display device for the default application) has been restored, the processor 34 activates the default application. When the display device has been restored, the processor 34 activates the default application, even if an execution device for the default application has not been restored.

It is assumed, for example, that the application “network printing” is set as the default application and the screen for the application “network printing” is set as the default screen. In this case, when an operation for turning on the image forming apparatus 10 was performed and the display device for the application “network printing” has been restored, the processor 34 activates the application “network printing”. For example, the network printing setting screen 58 is displayed on the display device 20 as the default screen. When the display device has been restored, the processor 34 activates the application “network printing” and displays a default screen for the application “network printing” (e.g., the network printing setting screen 58) on the display device 20, even if the execution device for the application “network printing” has not been restored.

When the display device for the application “network printing” has not been restored, the processor 34 displays, on the display device 20, a message indicating that the display device is not ready, until the restoration is completed.

As described above, when the default screen is set, too, the default screen is displayed after the display device is restored even if the execution device has not been restored.

In an example, the functions of the image forming apparatus 10 are achieved through cooperation of hardware and software. The functions of the image forming apparatus 10 are achieved, for example, when the processor 34 of the image forming apparatus 10 reads a program stored in the memory 30 and executes the program. The program is stored in the memory via a storage medium such as a compact disc (CD) or a digital versatile disc (DVD) or a communication path such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))
An information processing apparatus comprising:
a processor,
wherein, for each of applications, a device necessary to display a screen for the application and a device necessary to execute the application are defined, and
wherein the processor is configured to activate an application if a device necessary to display a screen for the application has been restored in a case where an instruction to activate the application is given after an operation for turning on the information processing apparatus is performed.
(((2)))
The information processing apparatus according to (((1))),
wherein the processor is configured to not activate the application if the device necessary to display the screen for the application has not been restored.
(((3)))
The information processing apparatus according to (((1))) or (((2))),
wherein the processor is also configured to:
   not execute the application if a device necessary to execute the application has not been restored, even in a case where an instruction to execute the application is given after the application is activated; and
   execute the application if the device necessary to execute the application has been restored in a case where an instruction to execute the application is given.
(((4)))
The information processing apparatus according to any one of (((1))) to (((3))),
wherein the processor is configured to:
   register, in a case where an instruction to activate an unregistered application, for which a device necessary to display a screen is not registered in the information processing apparatus, is given, a device accessed by the activated unregistered application before the screen is displayed after all devices had been restored as the device necessary to display the screen for the unregistered application; and
   register a device accessed by the unregistered application while the unregistered application is being accessed as a device necessary to execute the unregistered application.
(((5)))
The information processing apparatus according to any one of (((1))) to (((4))),
wherein the processor is configured to activate a predetermined application if a device necessary to display a screen for the predetermined application has been restored in a case where the screen for the predetermined application is to be displayed after the operation for turning on the information processing apparatus is performed.
(((6)))
The information processing apparatus according to any one of (((1))) to (((5))),
wherein the processor is configured to:
activate an application if a device necessary to display a screen for the application has been restored in a case where the information processing apparatus is turned on and an instruction to activate the application is given after information indicating a state of an executed program is stored in a memory, a function of supplying, to the memory, power necessary for the memory to hold the information without supplying power to the device is executed, and the information processing apparatus is turned off.
(((7)))
A program causing a computer, which controls an apparatus in which, for each of applications, a device necessary to display a screen for the application and a device necessary to execute the application are defined, to execute a process comprising:
activating an application if a device necessary to display a screen for the application has been restored in a case where an instruction to activate the application is given after an operation for turning on the apparatus is performed.

What is claimed is:

1. An information processing apparatus comprising:
a processor,
wherein, for each of applications, a device necessary to display a screen for the application and a device necessary to execute the application are defined, and
wherein the processor is configured to activate an application if a device necessary to display a screen for the application has been restored in a case where an instruction to activate the application is given after an operation for turning on the information processing apparatus is performed.

2. The information processing apparatus according to claim 1,
wherein the processor is configured to not activate the application if the device necessary to display the screen for the application has not been restored.

3. The information processing apparatus according to claim 1,
wherein the processor is also configured to:
not execute the application if a device necessary to execute the application has not been restored, even in a case where an instruction to execute the application is given after the application is activated; and
execute the application if the device necessary to execute the application has been restored in a case where an instruction to execute the application is given.

4. The information processing apparatus according to claim 2,
wherein the processor is also configured to:
not execute the application if a device necessary to execute the application has not been restored, even in a case where an instruction to execute the application is given after the application is activated; and
execute the application if the device necessary to execute the application has been restored in a case where an instruction to execute the application is given.

5. The information processing apparatus according to claim 1,
wherein the processor is configured to:
register, in a case where an instruction to activate an unregistered application, for which a device necessary to display a screen is not registered in the information processing apparatus, is given, a device accessed by the activated unregistered application before the screen is displayed after all devices had been restored as the device necessary to display the screen for the unregistered application; and
register a device accessed by the unregistered application while the unregistered application is being accessed as a device necessary to execute the unregistered application.

6. The information processing apparatus according to claim 2,
wherein the processor is configured to:
register, in a case where an instruction to activate an unregistered application, for which a device necessary to display a screen is not registered in the information processing apparatus, is given, a device accessed by the activated unregistered application before the screen is displayed after all devices had been restored as the device necessary to display the screen for the unregistered application; and
register a device accessed by the unregistered application while the unregistered application is being accessed as a device necessary to execute the unregistered application.

7. The information processing apparatus according to claim 1,
wherein the processor is configured to activate a predetermined application if a device necessary to display a screen for the predetermined application has been restored in a case where the screen for the predetermined application is to be displayed after the operation for turning on the information processing apparatus is performed.

8. The information processing apparatus according to claim 2,
wherein the processor is configured to activate a predetermined application if a device necessary to display a screen for the predetermined application has been restored in a case where the screen for the predetermined application is to be displayed after the operation for turning on the information processing apparatus is performed.

9. The information processing apparatus according to claim 1,
wherein the processor is configured to:
activate an application if a device necessary to display a screen for the application has been restored in a case where the information processing apparatus is turned on and an instruction to activate the application is given after information indicating a state of an executed program is stored in a memory, a function of supplying, to the memory, power necessary for the memory to hold the information without supplying power to the device is executed, and the information processing apparatus is turned off.

10. The information processing apparatus according to claim 2,
wherein the processor is configured to:
activate an application if a device necessary to display a screen for the application has been restored in a case where the information processing apparatus is turned on and an instruction to activate the application is given after information indicating a state of an executed program is stored in a memory, a function of supplying, to the memory, power necessary for the memory to hold the information without supplying power to the device is executed, and the information processing apparatus is turned off.

11. A non-transitory computer readable medium storing a program causing a computer, which controls an apparatus in which, for each of applications, a device necessary to display a screen for the application and a device necessary to execute the application are defined, to execute a process comprising:
activating an application if a device necessary to display a screen for the application has been restored in a case where an instruction to activate the application is given after an operation for turning on the apparatus is performed.

12. A method used by an apparatus in which, for each of applications, a device necessary to display a screen for the application and a device necessary to execute the application are defined, the method comprising:
activating an application if a device necessary to display a screen for the application has been restored in a case where an instruction to activate the application is given after an operation for turning on the apparatus is performed.
